(19) United States
(12) Patent Application Publication
(10) Pub. No.: US 2007/0147247 A1
(43) Pub. Date: Jun. 28, 2007

(54) Auto adaptive quality of service architecture and associated method of provisioning customer premises traffic

(75) Inventors: Ndiata Kalonji, San Francisco, CA (US); Manoj Mourya, Fremont, CA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: FRANCE TELECOM, Paris (FR)

(21) Appl. No.: 11/313,623

(22) Filed: Dec. 22, 2005

(51) Int. Cl. H04J 1/16

(52) U.S. Cl. 370/235

(57) ABSTRACT

A customer premises device is provided for monitoring quality of service (QOS) metrics between a network edge and a customer. The device includes a memory which stores at least one user profile, and, information regarding active sessions of traffic flow through the customer premises device. A hardware and/or software/firmware based controller monitors traffic flow between the customer and the network edge and receives requests for new active sessions. The processor accesses the at least one user profile stored in memory to identify a policy hierarchy with respect to active sessions of traffic flow upon receipt of a request to establish a new active session. The processor selects a candidate active session to be terminated based upon the policy hierarchy and terminates the selected session in accordance with information stored in memory regarding the selected session. In this manner, the processor enforces quality of service, for both upstream and downstream sessions, based upon the policy hierarchy of the user profile.

### BACKGROUND OF THE INVENTION

The present invention relates to a telecommunication architecture and associated method of extending quality of service (QOS) control beyond the network edge, and, more specifically, to an auto adaptive full duplex QOS mechanism for customer premises equipment (CPE), such as a residential/enterprise gateway.

The “background” description provided herein is for the purpose of generally presenting the context of the invention. Work of the presently named inventors, to the extent it is described in this background section, as well as aspects of the description which may not otherwise qualify as prior art at the time of filing, are neither expressly or impliedly admitted as prior art against the present invention.

Currently, QOS is primarily controlled internal to the network edge (i.e., network core or “backbone”) via a multitude of routing and resource allocation mechanisms. In a typical Wide Area Network (WAN) environment, the Internet for example, link-state routing protocols, MPLS, and/or MPLS related traffic engineering protocols, Diffserv, etc are leveraged to ensure a guaranteed level of bandwidth for meeting application and/or customer delivery requirements. Theses mechanisms may interface with carrier and edge policies to further improve communication latencies, and, to adjust traffic shaping metrics. While these techniques are highly effective, customer premises equipment, which by its nature is external to the network edge, cannot benefit from such network management schemes and QOS technologies.

Virtual Private Lan Services (VPLS) provides one solution to extending network management technologies and QOS control beyond the network edge. This mechanism is currently being pursued by the Internet Engineering Task Force (IETF) to provide metro Ethernet integration. However, competing protocols and methodology are complicating the adoption of this technology. Further, the adoption of such an increasingly complex layering of control and routing protocols is not a cost effective solution for residential and/or most smaller to medium sized enterprise customers.

In today's residential and/or home network envrionment, residential CPE equipment such as a gateway, cable modem, etc is provided to deliver basic connectivity to an external network. This basic interface provided by the service provider does not provide any QOS funtionality, nor can it shape traffic exchanged therethrough in an upstream or downstream direction. The extension of connectivity from an external network edge to CPE equipment is referred to as “the last mile.” As most of the traffic shaping is done at the edge of the network by the service provider, there exists a deficiency in QOS control in the last mile. Consequently, many residential customers, get very bad quality of service due to bandwidth limitations in the last mile.

For example, current residential services, whether offered over DSL, cable modem ,or by Wireless Service Provider (WISP), do not guarantee QoS to the customer. Such services include real time A/V streaming, Voice Over IP applications such as emergency 911 calling, on-line gaming and virtual reality environments, and so called “triple play” (IPTV) delivery etc. Likewise, there is no way by which a priority can be assigned to data streams in the last mile such that one data stream, or “active session,” can be given priority with respect to available last mile resources.

Accordingly, there is a need for an adaptive architecture which provides quality of service beyond the network edge to manage, at the session level, both upstream and downstream traffic for the last mile.

### SUMMARY OF THE INVENTION

The present invention provides a customer premises device or “gateway” to monitor and manage quality of service (QOS) levels for traffic between a network edge and a customer. The gateway includes a memory which stores at least one user profile, and, information regarding active sessions of traffic flow through the gateway. A hardware and/or software/firmware based controller monitors traffic flow between the customer and the network edge, and, manages requests for new active sessions. The controller initiates access to the at least one user profile stored in memory to identify a policy hierarchy with respect to active sessions of traffic flow upon receipt of a request to establish a new active session. The controller selects an active session to be terminated based upon the policy hierarchy and terminates the selected session in accordance with information stored in memory regarding the selected session. In this manner, the controller enforces quality of service, for both upstream and downstream sessions, based upon the policy hierarchy defined by the user profile.

In a further aspect of the invention, a method of policing quality of service (QOS) for active sessions of a customer premises device positioned between a network edge and a customer is provided. The method includes storing at least one user defined policy hierarchy, and, information regarding active sessions of traffic flow through the customer premises device. Active sessions between the customer and the network edge are monitored. Upon reception of a request for establishing a new active session, the memory is accessed for retrieving the at least one user profile. A policy hierarchy with respect to active sessions of traffic flow is identified from the at least one user profile, and, an active session is selected to be terminated in accordance with the at least one user defined policy hierarchy. The selected active session is discontinued in accordance with the information of the memory and the newly requested new active session is established. In this way, the quality of service policies are enforced for both upstream and downstream sessions, based upon the user defined policy hierarchy.

In still a further aspect of the invention, a method of policing quality of service (QOS) for active sessions of a customer premises device positioned between a network edge and a customer is provided. The method includes storing at least one user defined policy, and, information regarding active sessions of traffic flow through the customer premises device. Active sessions between the customer and the network edge are monitored, and, the memory is accessed for retrieving the at least one user profile. Groups of traffic metrics with respect to active sessions of traffic flow are identified from the at least one user profile, and, an active session is selected to be terminated upon violation of a metric defined in the user profile. The selected active session is discontinued in accordance with the information of the memory. In this way, the quality of service policies are enforced for both upstream and downstream sessions, based upon the user defined policy.

It is to be understood that both the foregoing general description of the invention and the following detailed description are exemplary, but are not restrictive, of the invention.

### BRIEF DESCRIPTION OF THE SEVERAL VIEWS OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a network diagram including the architecture of the present invention;

FIG. 2 is a block diagram of a gateway device in accordance with an exemplary architecture of the invention;

FIG. 3 is a high level block diagram of a guardian control module of the gateway device of FIG. 2;

FIG. 4 is a flowchart describing an exemplary traffic shaping operation of the control and management module of FIG. 3; and

FIG. 5 is a flowchart describing a further exemplary traffic shaping operation of the control and management module of FIG. 3.

### DETAILED DESCRIPTION OF THE INVENTION

Certain terminology used in the following description is for convenience only and is not limiting. The term “gateway” as used herein refers to hardware and/or software functioning to interface between a customer/enterprise and a provider edge. No functionality is either implied or inferred from the use of the term “gateway” aside from that described herein. Likewise, “customer premises” is not limited with respect to physical location, but, instead, merely denotes functionality with respect to the exchange of traffic with a customer. As such, the customer premises device (CPE) may be physically located at any distance from home network or enterprise network point of presence. The ability to pass communications therebetween being a function of the transmission range, power and wireless/hardwire application protocol of the respective devices. In the drawings, the same reference numerals are used for designating the same elements throughout the several figures.

The present invention is directed to a device for managing traffic flow between a customer and a network provider access point (AP). The AP or “customer premises device” in accordance with the present invention provides intelligent control of full duplex data streams to shape the upstream or downstream traffic from within the home network to address the “last mile problem.” The device admits, controls, and shapes both upstream and downstream traffic (inbound and outbound streams). Intelligence embedded in the customer premises device as described herein provides an architecture which polices quality of service and bandwidth management for every session in accordance with user defined priorities. The user defined priorities may dictate the management of additional active session requests to maintain minimum levels of performance, and/or dictate the termination of active sessions upon exceeding of such minimum levels by presently established active sessions.

In monitoring active sessions, the device in accordance with the present invention relates each active session of traffic to a priority level of a policy hierarchy provided in a user profile. Each session is associated with a profile that specifies in addition to other parameters, a session's priority level and a session's QoS parameters, such as maximum tolerable delay, minimum throughput, maximum variance of the delay (jitter), etc. In this way, a determination is made whether a session's policy has exceeded or fallen below a user defined requirement, or, can be supported by the network: (a) by either the network providing sufficient capacity or resources to support the QoS, or (b) by dropping some lower priority session to accommodate the QoS requirements of the higher priority session.

The present invention may be embodied to provide functions which are part of existing CPE equipment, such as residential gateways, to strictly monitor each session maintained by the gateway, to retrieve real-time information on the session, and to guarantee QoS for each session based on priority levels and the user profile. Such functions allow carriers to provision the maximum usage of the bandwidth by managing, via the residential gateway, the customer's bandwidth. Along these lines, the carrier may collect information on the traffic within the home network so that the ISP can offer a personalized package based on the traffic patterns of the user.

The present invention further provides an end-to-end QoS architecture that may manage several network segments. Similarly, auto learning mechanisms in the control plane of the present invention enable graceful termiantion of sessions for avoiding the delivery of rejected traffic to critical customer device ports.

I. Architecture

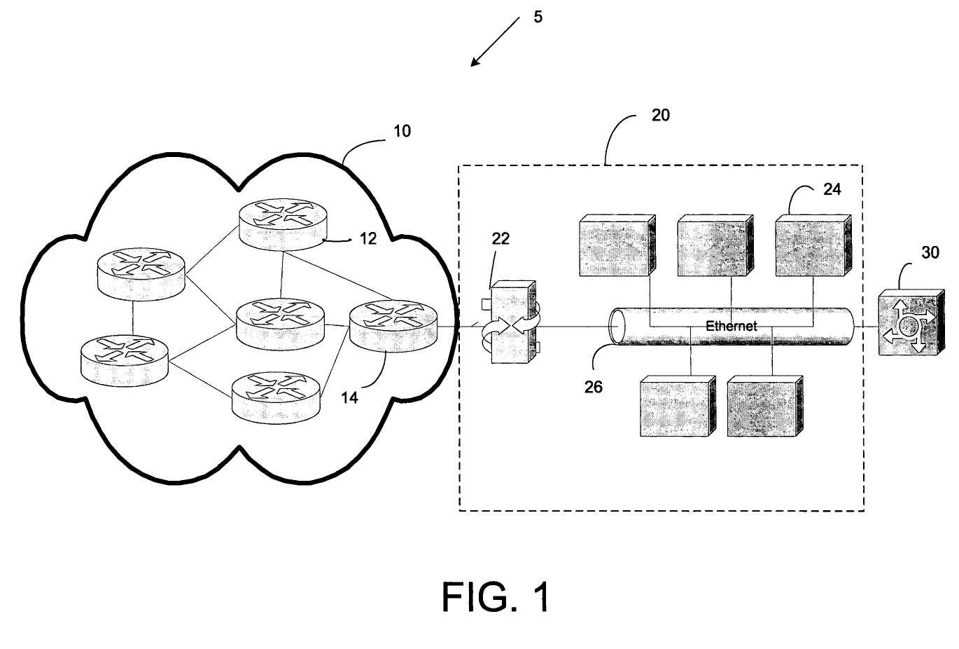

Refering now more specifically to FIG. 1, a network diagram, including the architecture of the present invention, generally designated 5, is shown. The network 10 is a wide area network, in the exemplary embodiment netowork 10 is the Internet. While network 10 is shown as a single cloud, of course, WAN network 10 may include sub-nets and component networks which are not depicted in FIG. 1 for the sake of simplicity and clarity of explanation. Likewise, network 10 can be a Local Area network (LAN). The network 10 includes a multitude of devices, routers, hosts etc. However, only core routers 12 and edge routers 14 are illustrated in FIG. 1 for exhibiting the high level functionality of the network 10 as a delivery medium. The monitoring and management of traffic in accordance with the present invention is between edge router 14 and customer premises 20.

Customer premises 20 may be a home network or enterprise network providing a CPE interface between a user and the edge of network 10. In this regard, customer premises 20 may include a co-located gateway 22 or similar CPE device. Of course, those skilled in the art will recognize that the exact location of gateway 22 is not limited to any specific physical location.

In the exemplary embodiment, the CPE is a gateway 22 of a residential home network. Those skilled in the art will recognize that CPE is not limited to gateway 22 and may instead be a Digital Subscriber Line (DSL) interface, a DOCSIS compliant device such as a cable modem, or an integrated device such as a set-top box including Microsoft® Media Center PC or Xbox 360®. Such devices may be configured to provide the same functionality of gateway 22, namely, managing connectivity between a plurality of active data stream sessions.

In the exemplary embodiment of FIG. 1, customer preimses 20 includes an Ethernet local area network (LAN) 26 for interconnecting customer devices, generally designated 24. The customer premises 20 in accordance with the present invention is not limited to any specific LAN technology, and, those skilled in the art will recognize that alternative hard wire and wireless technologies exist which will perform the same function and in the same manner, such as token ring, serial connection, USB, BlueTooth®, Wi-Fi, WiMax, cellular technologies, radio frequency (RF), infrared and the like. Likewise, the customer premises 20 may not employ any LAN at all, simply provide connectivity to a single customer device 24. Customer devices 24 are generally depicted for the purposes of expressing the broad scope of devices that may be found in such an enterprise or home environement, including PDAs, PCs, Internet Appliances, cell phones, media centers and the like.

In an alternative embodiment, the customer premises 20 is operably linked to a profile server 30 for distributing user profiles to gateway 22. The server 30, while shown separate from customer premises 20, may be resident with in LAN 26, likewise, identical functionality may be provided by an Internet Service provider (ISP) of network 10. When situated external to the LAN and under control of an ISP, a security negotiation may be performed prior to the distribution or modification of user profiles resident on gateway 22. This security negotiation may be performed transparent to the user via an automatic updating mechanism for example. The implementation of encryption/authentication mechanisms for performing this negotiation are known to those skilled in the art. The server 30 enables carriers of network 10 to provision the maximum usage of the bandwidth by managing, via the gateway 22, the customer's bandwidth. Along these lines, the carrier may collect information on the traffic within the customer premises 20 so that personalized service packages based on the traffic patterns of the user can be provided.

The server 30 is separately depicted for describing its functionality only, and those skilled in the art will recognize that the server functionality to the extent it is desired may be provided by alternative devices and at alternative locations. In the exemplary embodiment, the functionality of server 30 is integrated in a command line interface of the gateway 22, and/or provided by customer devices 24 for defining user profiles as described further herein.

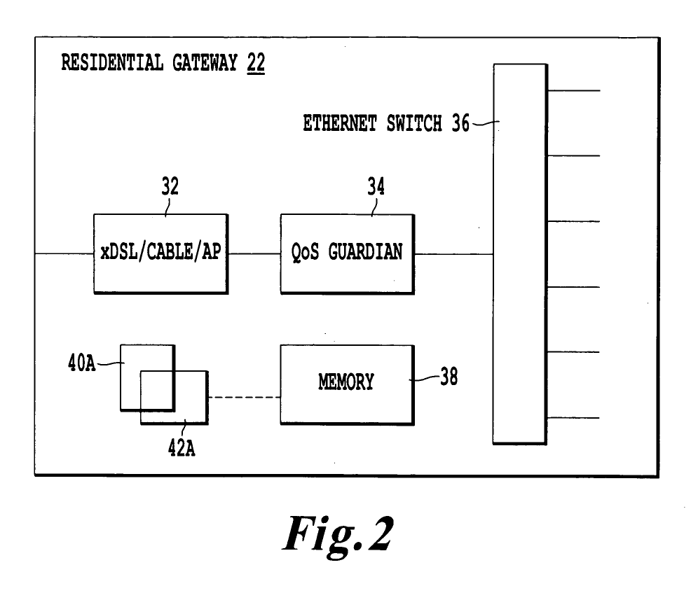

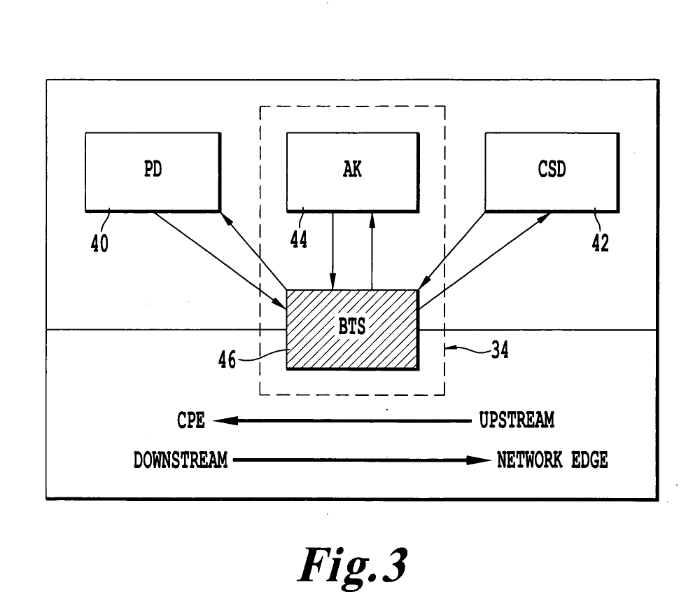

Referring more specifically to FIG. 2, a high level block diagram of the exemplary gateway 22. The gateway 22 includes connectivity module 32, a guardian control module 34, memory 38 and customer side interface 36. The gateway 22 communicates traffic from its customer side (upstream) to a downstream side of gateway 22 (shown in FIG. 3) via IPV4 or IPV6 in accordance with the TCP/IP protocol stack; those skilled in the art will recognize that alternative networking technologies are likewise embraced by the teachings of the present invention.

The connectivity module 32 generally provides the behavior outlined above for presenting an access point to the edge of network 10. In the exemplary embodiment, the connectivity module is cable modem which operates in accordance with the DOCSIS protocol.

The guardian control module 34 provides additional functionality to the connectivity module 32. In the exemplary embodiment, the guardian control module 34 functionality is performed by a software instruction set of a data processor (not shown). The instruction set may be in the form of application software and/or software drivers ported to the operating system of the gateway 22. In alternative embodiments, the guardian control module 34 may be embodied in firmware, programmable logic, via an Application Specific Integrated Circuit (ASIC).

Memory 38 may be integrated with the operation of guardian control module 34 via a scratchpad memory of a data processor of gateway 22. Similarly, memory 38 may be a separate volatile or non-volatile memory. The memory 38 is provided for storing user profiles 40a and session data 42a. In an alternative embodiment, memory 38 may further store authentication data (not shown) for negotiating access to user profiles 40a and session data 42a via server 30. Memory 38 is separately illustrated to represent functionality only; those skilled in the art recognize that the separate depiction in no way limits the implementation of the memory as a stand alone implementation of gateway 22. For example, memory 38 may be physically separate from gateway 22, or, resident at server 30 or a customer device 20.

The exemplary customer side interface 36 is an Ethernet switch for managing the delivery of traffic to one or more customer devices 20 of LAN 26. Those skilled in the art recognize that the customer side interface 36 is not limited to any specific LAN technology. Likewise, customer side interface 36 may provide non-LAN connectivity such as serial ports.

II. Control Functionality

Referring now more specifically to FIG. 3, a more detailed block diagram of guardian control module 34 is shown. The guardian control module 34 includes a bi-directional traffic shaper (BTS) 46, an Application Killer (AP) 44, policy database (including user profiles 40a, control session dictionary (CSD) 42 (including session data 42a).

FIG. 3 illustrates the functionality of guardian control module 34 interoperation with portions of memory 38 (CSD 42 and PD 40). The BTS 46 and Application Killer 44, although illustrated as individual executable components, may be agents of the same instruction set. Alternatively, the BTS 46 and/or AK 44 may be embodied in the form of individual software drivers of gateway 22.

The BTS 46 is a QoS policy enforcement point for both upstream and downstream traffic relative to the edge of network 10 and customer premises 20. The BTS 46 is the point of action/coordination between PD 40, AK 44, and CSD 42. The BTS 46 performs bi-directional state-full Layer 2-to-Layer 7 traffic shaping.

The BTS 46 communicates with PD 40 and user profiles 40a therein, to retrieve QoS policy for each service before establishing a requested session. If the required QoS for a new session is not available and if the session is a higher priority relative to an active session, the BTS 46 utilizes the AK 44 to terminate the already existing session of lower priority. Where a new session is requested to be established, if the new session is of lower priority relative to existing sessions based on a user defined profile, and/or a required QoS is not available, then the session may not be established.

Likewise, the BTS 46 can manage and control active session based on a group of user defined metrics to maintain a QOS for active sessions even when new requests are absent. For example, established active sessions may be terminated when they exceed certain user defined traffic metrics CSD 42 provides the control signals to stop the session based on data stored therein. The AK 44 cooperates with the BTS 46 to stop the active sessions by sending control messages to the source or sink of the stream (i.e., active session). AK 44 gets information about control messages and parameters from CSD 42 through BTS 46.

The policy database 40 is embodied in memory 38 and is a repository of QoS policy for all the possible services offered and also contains all the user profiles 40a. It helps BTS 46 in prioritizing the active sessions. PD 40 may be populated via server 30 of the network 10. The policy database 40 is accessed by the guardian control module 34 to provide the customer premises QOS management in accordance with the present invention. The exemplary user profile 40a of policy database 40 includes a policy data hierarchy which classifies priorities of traffic in accordance with user preferences. The exemplary hierarchy employs weighted values for identifying a traffic flow (i.e., session) of a higher importance to the user relative to others. Such a weighting system can assign a high priority to VOIP or video streamed traffic as opposed to FTP traffic.

Additionally, the exemplary policy data base 40 and user profiles 40a stored therein, may include further policy data such as session QoS parameters, maximum tolerable delay, minimum throughput, maximum variance of the delay (jitter), etc. In this way, a determination can be made by the guardian control module 34 as to whether a newly requested session can be supported by the network 10 based on this additional policy data of user profile 40: (a) by either the network providing sufficient capacity or resources to support the QoS, or (b) by dropping some lower priority session to accommodate the QoS requirements of the higher priority session.

The session data control information is used to tear down the session. The CSD 42 is a group of parameter sets such as session data 42a which are stored in the memory 38 for users and accessed by the guardian control module 34 to provide the customer premises QOS management in accordance with the present invention. The session data 42a is a parameter set stored in memory 38 to identify details of active sessions of traffic being exchanged through the gateway 22. The session data includes connection control data in state-full fashion. The CSD 42 may be populated externaly, for example by a server 30 of the network 10, or through a CLI of gateway 22.

III. Operation

Any processes descriptions or blocks in flow charts should be understood as representing modules, segments, portions of code which include one or more executable instructions for implementing specific logical functions or steps in the process, and alternate implementations are included within the scope of the exemplary embodiment of the present invention in which functions may be executed out of order from that shown or discussed, including substantially concurrently or in reverse order, depending upon the functionality involved, as would be understood by those skilled in the art.

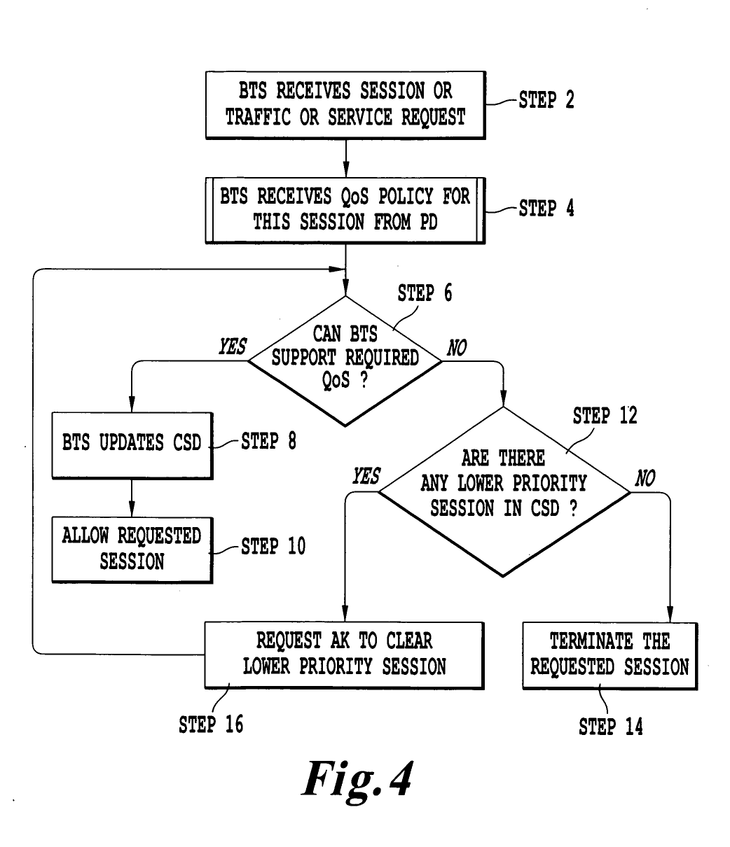

The flowchart of FIG. 4 describes the operation of the session establishment and termination for the guardian control module 34. Initially, the BTS 46 receives a session or service request to accommodate new upstream or downstream user traffic at step 2. The BTS 46 then retrieves the user profile 40a corresponding to the newly requested session from the PD at step 4. At step 6, a determination is made whether the BTS 46 can support the newly requested session. If, for example, the required QoS can be supported, then the BTS 46 updates the CSD 42 with the sessions parameters at step 8, and, allows the requested session at step 10. If, on the other hand, the BTS 46 cannot support the required QoS, a determination is then made at step 12 whether there are any active lower priority sessions in the CSD 42 that may be terminated to allow the new session. If such a lower priority session exists, then a request is made to the AK 44 to clear the lower priority session from the CSD 42, and allow the higher priority requesting session at step 16. If however there are no such lower priority sessions in the CSD 42, the requested session is terminated at step 14.

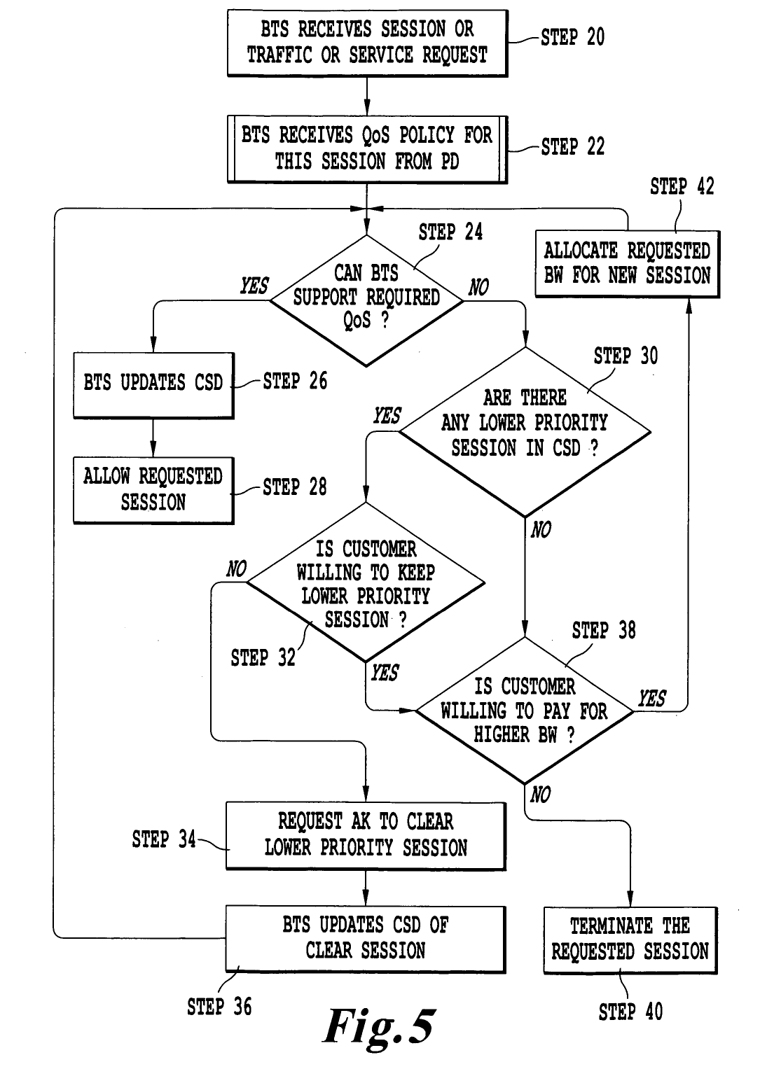

In an alternative embodiment, the AK 44 includes intelligence to update the PD 40 to respond to new requests from the end user in modifying the user profile 40a, and the CSD 42 stores all the sessions data for upload to a network server as shown in the flowchart of FIG. 5.

Referring now to the flow chart of FIG. 5, initially, the BTS receives session or service requests to accommodate new upstream or downstream user traffic at step 20. The BTS 46 then retrieves the user profile 40a for the newly requested session from the PD 40 at step 22. A determination is made at step 24 whether the BTS 46 can support the newly requested session. If, for example the required QoS can be suported, then the BTS 46 updates the CSD 42 with the newly requested session parameters at step 26, and allows the requested session at step 28. If the BTS 46 cannot support the required QoS of the session, then a determination is made at step 30 whether there are any lower priority sessions in the CSD 42 that may be dropped. If there are lower priority sessions in the CSD 42, a determination is then made whether the customer is willing to keep this low priority session at step 32. If the customer is not willing to keep this low priority session, at step 34, a request is made to the AK 44 to clear the lower priority session, and, at step 36, a request is made to the the BTS 46 to update the CSD 42 with respect to the cleared session. If however the customer is willing to keep the low priority session at step 32, a determination is then made if the customer is willing to pay for higher bandwidth at step 38. If not, the requested session is terminated at step 40. However, if the customer is willing to pay for higher bandwidth, the requested bandwidth is allocated to the new session at step 42.

Obviously, readily discernible modifications and variations of the present invention are possible in light of the above teachings. It is therefore to be understood that within the scope of the appended claims, the invention may be practiced otherwise than as specifically described herein. For example, while described in one or both of software and hardware components interactively cooperating, it is contemplated that the system described herein may be practiced entirely in software. The software may be embodied in a carrier such as magnetic or optical disk, or a radio frequency or audio frequency carrier wave.

Thus, the foregoing discussion discloses and describes merely exemplary embodiment of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

What is claimed is:

1. A customer premises device for monitoring and managing quality of service (QOS) metrics between a network edge and a customer, comprising:
a memory configured to store at least one user profile, and, information regarding active sessions of traffic flow through the customer premises device;
a processor executing an instruction set, the instruction set including:
i. a traffic shaping agent configured to monitor traffic flow between the customer and the network edge, the traffic shaping agent configured to access the at least one user profile stored in memory to determine a policy hierarchy with respect to active sessions of traffic flow, the policy hierarchy operative to identify an active session candidate for termination, and
ii. a session termination agent configured to function in cooperation with the traffic shaping agent and operative to terminate the candidate active session in accordance with the information of the memory corresponding to the candidate active session,
wherein, the instruction set of the customer premises equipment provides enforcement of a quality of service, for both upstream and downstream sessions, based upon the policy hierarchy of the user profile.

2. The customer premises device of claim 1, wherein the memory is operably linked to a means for updating the at least one user profile.

3. The customer premises device of claim 1, wherein the candidate active session is terminated via a control message of the session termination agent in accordance with information regarding the candidate active session stored in the memory.

4. The customer premises device of claim 3, wherein the candidate active session is selected upon a request to the customer premises device to establish a new active session.

5. The customer premises device of claim 4, wherein the new active session has a higher priority relative to the candidate active session with respect to the policy hierarchy of the user profile.

6. The customer premises device of claim 4, wherein the traffic shaping agent updates the information in memory pertaining to active sessions with session data, and, control information of the new active session upon establishment.

7. The customer premises device of claim 5, wherein the traffic shaping agent is configured to determine whether the policy hierarchy permits maintaining a lower priority, candidate active session, in exchange for an additional bandwidth charge.

8. A method of policing quality of service (QOS) for active sessions of a customer premises device positioned between a network edge and a customer, comprising:
storing at least one user defined policy hierarchy, and, information regarding active sessions of traffic flow through the customer premises device;
monitoring active sessions between the customer and the network edge;
receiving a request for establishing a new active session;
accessing the at least one user profile stored in memory;
identifying a policy hierarchy with respect to active sessions of traffic flow from the accessed at least one user profile;
selecting an active session to be terminated in accordance with the policy hierarchy;
discontinuing the selected active session in accordance with the information of the memory; and
establishing the requested new active session,
wherein, the instruction set of the customer premises device provides policing of a quality of service, for both upstream and downstream sessions, based upon the user defined policy hierarchy.

9. The method of claim 8, further comprising:
generating a control message to discontinue the selected active session in accordance with information regarding active sessions of traffic flow stored in the memory.

10. The method of claim 8, further comprising:
updating the information in memory pertaining to active sessions with session data and control information of the new session upon establishment and discontinuance of the selected active session.

11. The method of claim 8 further comprising:
determining whether the policy hierarchy permits maintaining the selected active session to be discontinued, in exchange for an additional bandwidth cost billed to the customer.

12. A gateway, comprising:
a memory configured to store a plurality of user profiles, and, information regarding active sessions of traffic flow through the gateway;
means for accessing the at least one user profile stored in memory to identify a policy hierarchy with respect to active sessions of traffic flow and a newly requested session; and
means for selecting an active session in accordance with the policy hierarchy; and
means for terminating the selected active session and establishing the newly requested session,
wherein, the gateway provides enforcement of a quality of service, for both upstream and downstream sessions, based upon the policy hierarchy of the user profile.

13. A computer readable carrier including executable instructions that cause a computer to implement a method of policing quality of service (QOS) for active sessions of a customer premises device positioned between a network edge and a customer, comprising:
storing at least one user defined policy hierarchy, and, information regarding active sessions of traffic flow through the customer premises device;
monitoring active sessions between the customer and the network edge;
receiving a request for establishing a new active session;
accessing the at least one user profile stored in memory;
identifying a policy hierarchy from the accessed at least one user profile with respect to active sessions of traffic flow;
selecting an active session to be terminated in accordance with the at least one user defined policy hierarchy;
discontinuing the selected active session in accordance with the information of the memory; and
establishing the requested new active session,
wherein, the instruction set of the customer premises equipment provides enforcement of a quality of service, for both upstream and downstream sessions, based upon the user defined policy hierarchy.

14. A method of policing quality of service (QOS) for active sessions of a customer premises device positioned between a network edge and a customer, comprising:
storing at least one user defined policy, and, information regarding active sessions of traffic flow through the customer premises device;
monitoring active sessions between the customer and the network edge;
accessing the at least one user profile stored in memory;
identifying a group of traffic metrics with respect to active sessions of traffic flow from the accessed at least one user profile;
selecting an active session to be terminated in accordance with a violated metric of the user profile;
discontinuing the selected active session in accordance with the information of the memory; and
wherein, the instruction set of the customer premises device provides policing of a quality of service, for both upstream and downstream sessions, based upon the user defined policy.
